(19) United States
(12) Patent Application Publication
(10) Pub. No.: US 2024/0025758 A1
(43) Pub. Date: Jan. 25, 2024

(54) METHOD OR PROCESS FOR FERRATE SYNTHESIS

(71) Applicant: BALDOTA ENVIROCARE PRIVATE LIMITED, Karnataka (IN)

(72) Inventors: Elangovan R, Karnataka (IN); Sridhar Pabbaraju, Karnataka (IN)

(21) Appl. No.: 18/256,905

(22) PCT Filed: Dec. 9, 2021
(86) PCT No.: PCT/IN2021/051155

§ 371 Date: Jun. 9, 2023

(30) Foreign Application Priority Data
Dec. 10, 2020 (IN) 202041053880

(51) Int. Cl. C01G 49/00; C02F 1/72

(52) U.S. Cl. CPC C01G 49/0027; C02F 1/72; C02F 2103/30

(57) ABSTRACT

The present invention relates to method/process of synthesis for ferrate synthesis. More specifically, it includes method for producing a liquid ferrate solution of oxidation of plus 6 stage, and discusses the apparatus and the raw materials and an improved greener process for synthesizing stable, high purity ferrate (VI) used for treating wastewater. The synthesis method involves three stages, namely, oxidation of hematite ore, followed by ferrate with chlorine under alkaline conditions and addition of stabilizing agent to improve shelf life of liquid ferrate solution for minimum 6 weeks. The process results in the efficient and effective productions of ferrate with high yields and small amounts of waste production. The synthesized chemical ferrate (VI) through the present invention has resulted in the effective reduction of BOD, COD and TSS.

### FIELD OF INVENTION

The present invention relates to a method for synthesis of ferrate. More specifically, the present invention discusses a method for production of metal ferrates directed for treating waste water.

### BACKGROUND OF THE INVENTION

Wastewater contains non-biodegradable contaminants enter aquatic bodies with out undergoing treatment in a biological treatment system and are hazardous to aquatic life and environment. Therefore, it is at most necessary to treat all pollutants before discharge of wastewater into environment.

One of the methods of treating the waste water is by way of using ferrate. Ferrate is a strong oxidant obtained by oxidizing iron in the valence state to trivalent (III) with iron in the valence state to hexavalent (VI). Several synthetic methods, such as chemical oxidation have been used for a long time. In all oxidation reactions, the final iron product is non-toxic ferric ions that form hydroxide oligomers, following agglomeration and settling down, thereby removing suspended particulate matter.

Ferrate can replace the chlorine, ozone and H2O2 in the pre-oxidation stage of water and partly the iron and aluminum salts [FeCl3 and Al2(SO4)3] that are function as coagulating and flocculating agents. Furthermore, the decomposition of the ferrate, generates alkaline media favorable to the precipitation of heavy metals into hydroxides. These properties make the ferrate ion an ongoing material particularly interesting and valuable for the treatment of water.

The use of ferrate as a dual-function chemical reagent offers significant advantages in terms of a more simplified and cheaper process i.e. use of a single chemical, single dosing and mixing system, lower equivalent chemical cost and less sludge production and of avoiding the formation of reaction by-products of toxicological concern. Ferrate offers an economical and environmental friendly alternative to conventional water and wastewater treatment technologies.

Ferrate is a supercharged iron molecule in which iron is in the plus 6 oxidation state and has potential application for water and wastewater treatment. This is due to its multi-functional nature namely oxidation, flocculation, and elimination of heavy metals, decomposition of organic matter and the like.

Conventional approaches for ferrate synthesis is Fe are electrolysis, alkali melting; oxidation of Fe (III) by a strong oxidizing agent in a concentrated alkaline solution. The most well-known synthesis methods for potassium ferrate synthesis are those involving the chemical and/or electrochemical oxidation of iron (II) and (III) from aqueous solutions having a high alkali concentration. There are several other methods used to synthesize ferrate for treating wastewater.

The patent EP0082590B1 discusses on method for synthesizing ferrate for waste water treatment wherein the first step comprises chlorine alkali process KCL+H2O=Cl2+KOH followed by Liquid Ferrate Process: Ferric Salt+KOH+Cl=K2FeO4+H2O and then Stabilizing process using a stabilizing agent and finally the crystallization process occurs and yields dry K2FeO4 salt.

Similarly the U.S. Pat. No. 8,961,921B2 discusses on synthesis of solid ferrate intermediate material; Iron(III) oxide+Na202=Na2FeO2 (Process temp 400-650° C.) followed by Liquid Ferrate Process; Na2FeO2+(OCl—, Cl2, Br2, I2, O3)=Na2FeO4 which is stable at 2 weeks.

Another patent application U.S. Pat. No. 4,545,974A discusses on a method of synthesis of ferrate wherein first step includes solid ferrate intermediate material synthesis: Fe2O3 or Fe3O4+Alkali metal Nitrogen compound ((KNO3, NanO3, CsNO3, Rb NO3)+gas (N2, Argon) at a process temperature of 780-1100° C.) followed by liquid ferrate process: intermediate material+KOH+Hypochlorite=K2FeO4.

Although the methods disclosed in the prior-arts provides a high content of ferrate in the synthesis product in pilot scale and obtaining the target final product in large quantities by current technologies is complex and involves a high consumption of chemicals and also poses a serious threat while synthesizing and for its further disposal in the environment.

The prior arts also do not discuss ferrate with plus 6 oxidation states that has high potential for oxidation, flocculation, and elimination of heavy metals, decomposition of organic matter and the like.

None of the existing technologies provide a process for producing ferrate in plus 6 oxidation state using raw materials hematite (Fe2O3) iron ore, Caustic soda, soda ash and chlorine and that do not yield toxic by-products. Similarly, the prior-arts do not discuss technologies that produce ferrate VI that has high stability and that are also cost-effective. This has been a major obstacle to the wide application of ferrate in wastewater treatment processes.

Considering all the drawbacks in the existing technologies, the present invention has developed a method of synthesis of ferrate (VI) that has three major steps to yield ferrate using non-toxic raw materials and also having high stability and shelf-life.

### OBJECTIVES OF THE PRESENT INVENTION

The primary objective of the present invention synthesizes an iron (VI) derivative, the sodium ferrate using the raw materials hematite (Fe2O3) iron ore, Caustic soda, soda ash and chlorine. This liquid sodium ferrate is stabilized by stabilizing agent and is a strong oxidizer and the by-product is an iron III salt, which is non toxic and reacts as a coagulant in the treatment of water and wastewater.

Another objective of the present invention is to synthesize ferrate involving three stages, namely, oxidation of hematite ore to sodium ferrite followed by Sodium di-oxo ferrate(III) with chlorine under alkaline conditions and addition of stabilizing agent to improve stability of liquid ferrate solution.

Another objective of the present invention is to provide a greener process to yield ferrate with less toxic by-products and ferrate with extended shelf-life.

Another objective of the present invention is to provide an economical method for producing ferrate VI by way of avoiding the formation of toxic by products.

### SUMMARY OF THE INVENTION

The following summary is provided to facilitate a clear understanding of the new features in the disclosed embodiment and it is not intended to be a full, detailed description. A detailed description of all the aspects of the disclosed invention can be understood by reviewing the full specification, the drawing and the claims and the abstract, as a whole.

In an embodiment of the present invention the method produces an iron (VI) derivative, the sodium ferrate. The raw materials used herein are hematite (Fe2O3) iron ore, Caustic soda, soda ash and chlorine.

In another embodiment of the present invention the liquid sodium ferrate is stabilized by stabilizing agent and is a strong oxidizer; the by-product is an iron III salt, not toxic, that reacts as a coagulant in the treatment of water and wastewater.

The proposed system implements the objective using a method involves three stages, namely, oxidation of hematite ore to sodium ferrite followed by Sodium di-oxo ferrate(III) with chlorine under alkaline conditions and addition of stabilizing agent to improve shelf life of liquid ferrate solution. The stages are follows

1st Stage: In this step intimate mixture of caustic soda and hematite ores is heated to redness in a reverberatory furnace or rotary furnace.

Fe2O3+Na2CO3----------2NaFeO2+CO2

Hematite (Fe2O3) iron ore reacts with sodium carbonate to produce sodium ferrite and carbon dioxide. Fusion reaction mixture at a temperature of 800 to 1000° C.

2nd Stage: 2NaFeO2+3Cl2+8NaOH---------2Na2FeO4+6NaCl+4H2O

Sodium di-oxo ferrate (III) reacts with chlorine and sodium hydroxide to produce sodium ferrate, sodium chloride and water. This reaction takes place at a temperature of 50-60° C.

3rd Stage: Addition of stabilizing agent to improve shelf life of liquid ferrate solution. The preferred stabilizers are mixer of alkali metal iodine salt (as KIO4, NaIO4, KTeO4) and metal silicate salts.

### BRIEF DESCRIPTION OF THE DRAWINGS

Other features and advantages of the present invention will become apparent from the detailed description of the invention which follows, when considered in light of the accompanying drawings in which:

FIG. 1 illustrates the process for synthesis of liquid ferrate

FIG. 2 illustrates the intermediate product ferrate being formed identified through the colour change of the product

FIG. 3 illustrates the final product

FIG. 4: shows UV-Vis absorbance spectra of (a) Intermediate product Sodium ferrite, (b) Liquid Na2FeO4

### REFERENCE

Where ‘RM refers to raw material

RM-1: Hematite (Fe2O₃) iron ore

RM-2: Sodium carbonate/Soda Ash

RM-3: Sodium hydroxide/Caustic soda

RM-4: DM water

RM-5: Chlorine gas

RM-6: Stabilizing agent

### DETAILED DESCRIPTION OF THE INVENTION

The principles of operation, design configurations and evaluation values in these non-limiting examples can be varied and are merely cited to illustrate at least one embodiment of the invention, without limiting the scope thereof.

The embodiments disclosed herein can be expressed in different forms and should not be considered as limited to the listed embodiments in the disclosed invention. The various embodiments outlined in the subsequent sections are construed such that it provides a complete and a thorough understanding of the disclosed invention, by clearly describing the scope of the invention, for those skilled in the art.

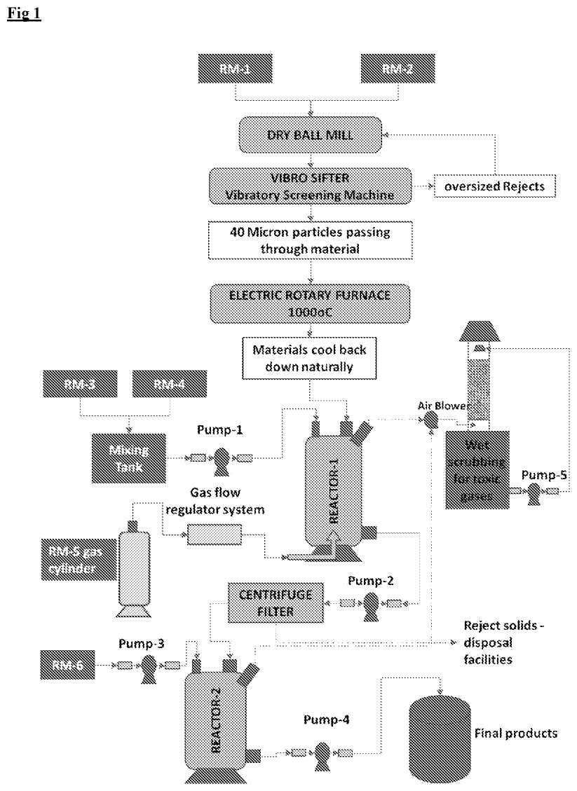

The present invention relates to a method of manufacturing ferrates specifically to ferrates having a oxidation value of plus 6, as illustrated in FIG. 1 and to the use of the ferrates thus obtained. The invention can be applied especially in the field of wastewater treatment.

According to a particular embodiment of the invention, the initial step is to add intimate mixture of caustic soda and hematite ores heated to redness in a reverberatory furnace or rotary furnace.

Fe2O3+Na2CO3-----2NaFeO2+CO2

followed by Hematite (Fe2O3) iron ore reacting with sodium carbonate to produce sodium ferrite and carbon dioxide at a temperature of 900° C.

2NaFeO2+3Cl2+8NaOH------2Na2FeO4+6NaCl+4H2O

The resultant Sodium di-oxo ferrate (III) reacts with chlorine and sodium hydroxide to produce sodium ferrate, sodium chloride and water. This reaction takes place at a temperature of 50-60° C. Finally, stabilizing agent is added to improve the shelf life of liquid ferrate solution.

The method of synthesis of ferrate includes initially adding 80 to 100 Units of Chemical (RM1) and 55 to 70 Units of Chemical (RM2) is mixed in Dry Ball mill and it is operated for the duration of 3 to 4 hours. In ball mill the larger size particles are broken by the balls and results in smaller broken particles. At the end of the process, the final product is sent to the Vibro Sifter for screening. During the process of screening the particles collected above 40 Microns (over sized particles) are again returned to the Dry ball mill for further breaking purpose, and the particles which measure below 40 Micron particles are taken forward to the next stage. The particles below 40 Micron are sent to processing in Electric Rotary Furnace where they are subjected to a temperature of 800-1000° C. for 4 hours. During this operation time the material colour changes is observed from brownish to greenish. The appearance of the greenish tinge is indicative of formation of ferrate. After the completion of 4 hours operation time the material is kept outside safe for natural cooling purpose for a time period of around 6-8 hours once the natural cooling process is completed, the material is sent to the Reactor 1. 680 Units of chemical (RM3) and 200 Units of chemical (RM4) is mixed in the mixing tank using agitators and pumped to the Reactor 1 where the cooled product is kept. Further to this, addition of 133 Units chemical in the form of gas (RM5) is also sent to the Reactor 1 through gas flow regulator systems through bottom to top direction. Reactor 1 is operational for the duration of 2 to 3 hours and maintaining the temperatures from 50 to 60° C. At the end of the process the product colour changes its colour to purple indicating the final product ferrate has been almost formed. The colour change of the product is shown in FIG. 2.

The product from the Reactor 1 is pumped to the Centrifuge Filter for filtration. The filtered materials are sent to the Reactor 2 for further processing and the remaining deposited solids in the filters are taken for disposal purpose. The toxic gases generated from the Reactors 1 & 2 during the processes are sent to the wet scrubbing unit for absorption. Wet scrubbing unit comprises one blower is used to generate the fresh air and one pump equipped to spray the water from top to bottom of the column.

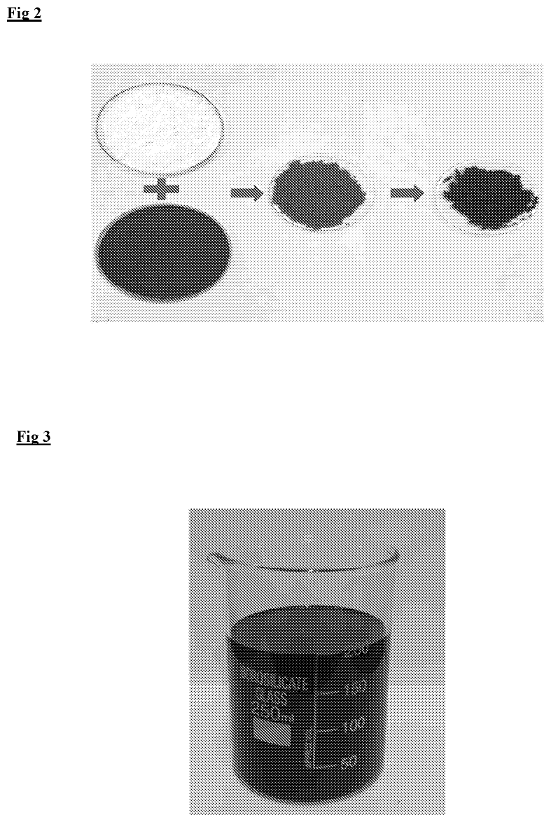

Further to this 25 Units of chemical (RM6) is pumped to the Reactor 2. One agitator is provided in the Reactor 2 for mixing the product received from the Reactor 1 and the chemical (RM6). Both are sent to Reactor 2 and the reactor is operated for the duration of 15 minutes. After the completion of process the final product liquid ferrate is formed and it is pumped to the final product storage tanks. The final product is shown in FIG. 3. The shelf life of the ferrate produced is six weeks.

In a preferred embodiment of the present invention the method for synthesizing ferrate comprises of mixing first reactant mixture hematite (Fe2O3) iron ore reacting with second reactant mixture sodium carbonate and then combining the first reactant and second reactant mixture at an optimum temperature, The resultant NaFeO2 is combined with the fifth reactant mixture chlorine and third reactant sodium hydroxide to produce sodium ferrate, sodium chloride and water at an optimum temperature.

Experimental Studies:

Waste water from the different types of industries such as but not limited to Pharmaceutical, Tannery, Textile, Food Processing and Domestic sewages are collected and its characteristics are checked in the laboratory and treated by Ferrate within the treatment capacity of 20 Litres. It consists of Reactor tank (aeration), Settling Tank and followed by Sand & Carbon Filters. Reaction time in Aeration is 4 hours and the Settling tank reaction time is 2 hours. After that the final treated water characteristics are checked and the test results are mentioned in below detail.

Terminologies used: BOD: Biochemical Oxygen Demand; COD: Chemical Oxygen Demand; TSS: Total Suspended Solids;

Experimental Study 1: Pharmaceutical wastewater treatment using Ferrate.

| Parameters | Raw Effluent | Treated Effluent |
|---|---|---|
| TDS, mg/L | 5800 | 5900 |
| TSS, mg/L | 470 | 10 |
| BOD, mg/L | 2300 | 30 |
| COD, mg/L | 4750 | 200 |
| pH | 7.4 | 8.3 |

Dosage: 4.5 ml/L

### Efficiency

Using Ferrate (VI), the removal efficiencies are as follows

### BOD—98.5%

### COD—96%

### TSS—98%

Experimental Study 2: Textile wastewater treatment using Ferrate (VI).

| Parameters | Raw Effluent | Treated Effluent |
|---|---|---|
| TDS, mg/L | 2000 | 2100 |
| TSS, mg/L | 650 | 10 |
| BOD, mg/L | 350 | 10 |
| COD, mg/L | 1050 | 100 |
| pH | 7.4 | 7.9 |
| Colour: | Dark | ≤10 |

Ferrate Dosage: 1.5 ml/L

### Efficiency:

Using Ferrate, the removal efficiencies are as follows

### BOD—97%

### COD—90%

### TSS—98%

Experimental Study 3: Food processing wastewater treatment using Ferrate.

| Parameters | Raw Effluent | Treated Effluent |
|---|---|---|
| TDS, mg/L | 5200 | 5640 |
| TSS, mg/L | 900 | 20 |
| BOD, mg/L | 3800 | 25 |
| COD, mg/L | 6460 | 180 |
| pH | 7.6 | 8.3 |

Ferrate Dosage: 4 ml/L

### Efficiency:

Using Ferrate, the removal efficiencies are as follows

### BOD—99%

### COD—97%

### TSS—98%

Experimental Study 4: Domestic sewage wastewater treatment using Ferrate

| Parameters | Raw Effluent | Treated Effluent |
|---|---|---|
| TDS, mg/L | 1800 | 500O |
| TSS, mg/L | 320 | ≤10 |
| BOD, mg/L | 360 | 10 |
| COD, mg/L | 540 | 45 |
| pH: | 7.1 | 7.6 |

Ferrate Dosage: 0.3 ml/L

### Efficiency:

Using Ferrate, the removal efficiencies are as follows

### BOD—97%

### COD—91%

### TSS—96%

Experimental Study 5: Tannery wastewater treatment using Ferrate

| Parameters | Raw Effluent | Treated Effluent |
|---|---|---|
| TDS, mg/L | 2450 | 2000 |
| Oil & Grease, mg/L | 150 | 5 |
| BOD, mg/L | 2150 | 20 |
| COD, mg/L | 3900 | 80 |
| Sulphide (as S)—, mg/L | 150 | <1 |
| Total Chromium, mg/L | 180 | <2 |
| pH | 8.2 | 8.9 |

Ferrate Dosage: 4 ml/L

### Efficiency:

Using Ferrate, the removal efficiencies are as follows

### BOD—98.5%

### COD—96%

Based on the above experiments, the synthesized chemical ferrate of the present invention has resulted in the reduction of BOD, COD and TSS.

Characterization of stage wise sodium ferrate (VI) was done by using scanning electron microscope (SEM) with element detection sensor (EDS), X-ray diffraction (XRD), Fourier transform infrared spectroscopy (FT-IR) and UV-Vis absorbance spectra(UV-Vis).

The surface morphology and elemental detection of stage wise synthesis of sodium ferrate were studied by using scanning electron microscope (SEM) (Carl Zeiss, EVO 10, Germany) with element detection sensor (EDS) (Oxford instruments, X-MaxN 80, United Kingdom). EDX spectral analysis depicted the presence of carbon, oxygen and iron in samples of stage wise synthesis of sodium ferrate as shown FIG. 1 and table 1. The Fe, Na and 0 value indicates oxidation of hematite ore (mixture of caustic soda and hematite ores) to Sodium di-oxo ferrate (III) at 1st Stage. Similarly, Na, Fe, O and Cl— Value indicate Sodium di-oxo ferrate (III) reacts with chlorine and sodium hydroxide to produce sodium ferrate, sodium chloride and water.

TABLE 1
The major elemental composition of stage
wise synthesis of sodium ferrate

| | | Mixture of | Intermediate | Final | |
|---|---|---|---|---|---|
| | Hematite | caustic soda | product | product of | |
| | (Fe2O3) | and hematite | Sodium | Sodium | End |
| Element | iron ore | ores | ferrite | ferrate | residue |
| C, % | 4.59 | 8.41 | — | — | 6.51 |
| O, % | 20.46 | 32.11 | 25.87 | 52.03 | 50.92 |
| Na, % | 1.47 | 17.08 | 19.69 | 26.07 | 17.79 |
| Al, % | 0.42 | 1.69 | 1.89 | — | 5.97 |
| Fe, % | 63.71 | 37.18 | 47.12 | 7.3 | 6.37 |
| Si, % | 3.12 | 1.38 | 2.86 | — | 5.83 |
| Cl—, % | | | | 13.61 | 1.96 |

Functional Groups Analysis

To characterize the stage wise sodium ferrate (VI) produced, IR spectroscopy (IR Tracer 100 AH, Shimadzu, Japan) was used. The FT-IR spectrum of Hematite RM1, Mixture of caustic soda and hematite ores, Intermediate product Sodium ferrite, Liquid Na2FeO4 and waste residue showing various IR absorption peaks (functional groups).

The stretching vibration characteristic peaks of the Fe—O bond in ferrate were obtained at around 450-500 cm 1, and confirmed the presence of the Fe—O bond in the crystals, which is sodium ferrate (VI) salt. The small difference in chemical shifts of functional groups of the product of this study compared with the literature could be caused by the conditions of production and crystallization.

Moreover, the spectrum shows a strong and broad absorption band centered around 3500 cm 1 as well as two strong absorption bands at about 1657 and 1623 cm 1. These bands are attributed to the stretching and bending vibrations of water. The water might be crystalloid or adsorbent water. The peaks obtained between 2400 and 4000 cm 1 are ascribed to the H—O bond from water. Additionally, the visibility and the sharpness of the peaks also can confirm the high purity of the product.

The X-ray diffractometer (XRD) (Rigaku corporation, Ultima IV, Tokyo, Japan) and the XRD patterns were analyzed by scanning from 2-theta (2θ) ranging between 4.00 and 80.00-. Sharp peaks of crystalline of Na2FeO4 at 20 values are 32-, 45.5-, 48.3- and 56.35- and 75.5- were more visible, compared to the reference (sodium ferrite). From the analytical point of view, the XRD is one of the analytical tools used to verify the presence of crystallinity of ferrate salts.

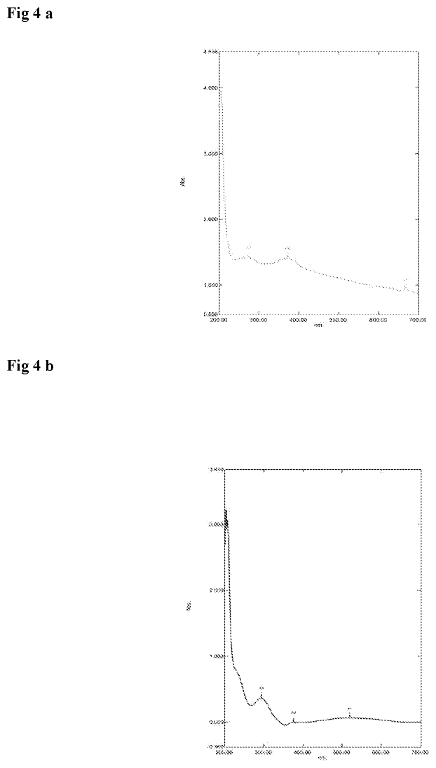

In the present invention the aqueous solution of ferrate, which is red-violet in color gives a characteristic absorption maximum at around 500 and 800 nm. It was confirmed by two respective minimum absorbance peaks at 396 nm and 519 nm on UV-Vis spectrum as illustrated in FIG. 4 (a, b). As can be seen from the detailed description of the present invention, the proposed method for producing ferrate VI results in a highly stable, less toxic final product. The present invention uses raw material that are entirely different from existing methods and do not have peroxide formation that is highly toxic.

While the foregoing written description of the invention enables one of ordinary skill to make and use what is considered presently to be the best mode thereof those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I/We claim:

1. A method for synthesizing ferrate comprising:
a. allowing first reactant mixture hematite (Fe2O3) (RM 1) iron ore to react with second reactant mixture sodium carbonate (RM 2); at an optimum temperature of around 900 C;
Fe2O3+Na2CO3-----2NaFeO2+CO2
b. subjecting the resultant NaFeO2 with the fifth reactant mixture chlorine (RM 5) and third reactant sodium hydroxide (RM 3) to produce sodium ferrate, sodium chloride; where the water (RM 4) acts as the fourth reactant mixture;
2NaFeO2+3Cl2+8NaOH------2Na2FeO4+6NaCl+4H2O
c. combining the reactant mixtures at an optimum temperature of 50 to 60 C;
d. absorbing toxic gases
e. stabilizing the resultant final mixture by the addition of sixth reactant mixture, the stabilizing agent (RM 6)

2. The method for synthesizing ferrate as claimed in claim 1 wherein the first reactant mixture and second reactant mixture is combined in the dry ball mill and forwarded to vibro sifter for screening and processed in electric rotary furnace.

3. The method for synthesizing ferrate as claimed in claim 1 wherein the resultant ferrite is combined with third reactant mixture and fourth reactant mixture in a mixing tank by agitation and sent to reactor and filtered.

4. The method for synthesizing ferrate as claimed in claim 1 wherein the toxic gases generated are absorbed in the wet scrubbing unit.

5. The method for synthesizing ferrate as claimed in claim 1 wherein the final mixture obtained is liquid ferrate and is stabilized by adding stabilizing agent to improve shelf life of liquid ferrate solution.

6. The shelf life of liquid ferrate claimed in claim 5, is minimum 6 weeks.
